(19) United States
(12) Patent Application Publication
(10) Pub. No.: US 2016/0277809 A1
(43) Pub. Date: Sep. 22, 2016

(54) INFORMATION OUTPUT APPARATUS, INFORMATION OUTPUT METHOD AND COMPUTER READABLE RECORDING MEDIUM

(71) Applicant: CASIO COMPUTER CO., LTD., Tokyo (JP)

(72) Inventors: Yoichi Murayama, Tokyo (JP); Hirokazu Kanda, Tokyo (JP); Akihito Iwadate, Tokyo (JP); Yoshinari Miyazaki, Tokyo (JP)

(21) Appl. No.: 15/012,921

(22) Filed: Feb. 2, 2016

(30) Foreign Application Priority Data
Mar. 16, 2015 (JP) 2015-052511
Sep. 16, 2015 (JP) 2015-182448

(51) Int. Cl. H04N 21/81; H04N 21/4363; H04N 21/84; H04N 21/236

(52) U.S. Cl. CPC H04N 21/812; H04N 21/236; H04N 21/43637; H04N 21/84

(57) ABSTRACT

According to an embodiment of the present invention, an information output apparatus includes a content output unit configured to output a content, and a broadcast unit configured to broadcast information related to the content which is being output by the content output unit.

### CROSS-REFERENCE TO RELATED APPLICATIONS

This application is based upon and claims the benefit of priority under 35 USC 119 of Japanese Patent Application No. 2015-052511 filed on Mar. 16, 2015, and Japanese Patent Application No. 2015-182448 filed on Sep. 16, 2015 the entire disclosure of which, including the description, claims, drawings, and abstract, is incorporated herein by reference in their entirety for all purposes.

### BACKGROUND OF THE INVENTION

1. Field of the Invention

The present invention relates to an information output apparatus, an information output method and a computer readable recording medium.

2. Description of the Related Art

Conventionally, it is generally performed to play back contents of an advertisement of a product for sale automatically by using an apparatus capable of outputting an image and/or a voice in various shops or superstores for customers visiting there.

There has been known an information processing apparatus for outputting a coupon of a store in which services to be provided are described in correspondence with numbers of visits to the store of a customer having a membership card of the store in the case that the number of visits reaches a predetermined number of times, as disclosed in Japanese Patent Application Laid-Open Publication No. 2014-52816 published on Mar. 20, 2014.

Further, there has been known a technology for installing beacon devices using a short range wireless connectivity standard such as Bluetooth (Registered Trademark) in a plurality of places in a commercial facility and sending service information corresponding to each of the places to communication terminals of users in the place within a fixed range.

However, as the automatic playback of the advertisement and the sending of the service information to users have been separately performed, it has been impossible to send or provide supplementary service information related to an advertisement to the users within a proper range corresponding to the advertisement.

### SUMMARY OF THE INVENTION

The present invention was made in light of the problem mentioned above, and an object of the present invention is to provide an information output apparatus, an information output method and a computer readable recording medium for recording a program for sending supplementary information related to information which is being output within a proper range.

According to an aspect of the invention, an information output apparatus is provided. The information output apparatus includes a content output unit configured to output a content, and a broadcast unit configured to broadcast information related to the content which is being output by the content output unit.

Advantages of the invention will be set forth in the description which follows, and in part will be obvious from the description, or may be learned by practice of the invention. Advantages of the invention may be realized and obtained by means of the instrumentalities and combinations particularly pointed out hereinafter.

### BRIEF DESCRIPTION OF THE DRAWINGS

The accompanying drawings, which are incorporated in and constitute a part of the specification, illustrate embodiments of the invention, and together with the general description given above and the detailed description of the embodiments given below, serve to explain the principles of the invention.

Here:

FIG. 1 is a diagram for showing an overall configuration of an electronic notification system relating to an embodiment of an information output apparatus of the present invention.

FIG. 2 is a block diagram for showing an electronic circuit of an advertisement information output apparatus 10 of the electronic notification system.

FIG. 3 is a diagram for showing an example of data structure in a FLASH ROM 24a and a RAM 24b of a work memory 24 of the advertisement information output apparatus 10.

FIG. 4 is a flow chart for showing an information output process performed by the advertisement information output apparatus 10 according to an embodiment of the present invention.

FIG. 5 is a flow chart for showing a process performed by a communication terminal 30 of the electronic notification system according to an embodiment of the present invention.

FIG. 6 is a diagram for showing an example of an HCI command.

FIG. 7 is a flow chart for showing an information output process performed by the advertisement information output apparatus 10 according to an embodiment of the present invention.

FIG. 8 is a diagram for showing an example of data structure in the FLASH ROM 24a and the RAM 24b of the work memory 24 of the advertisement information output apparatus 10.

### DETAILED DESCRIPTION OF THE PREFERRED EMBODIMENT

Hereinafter, embodiments of the present invention will be described with reference to the accompanying drawings.

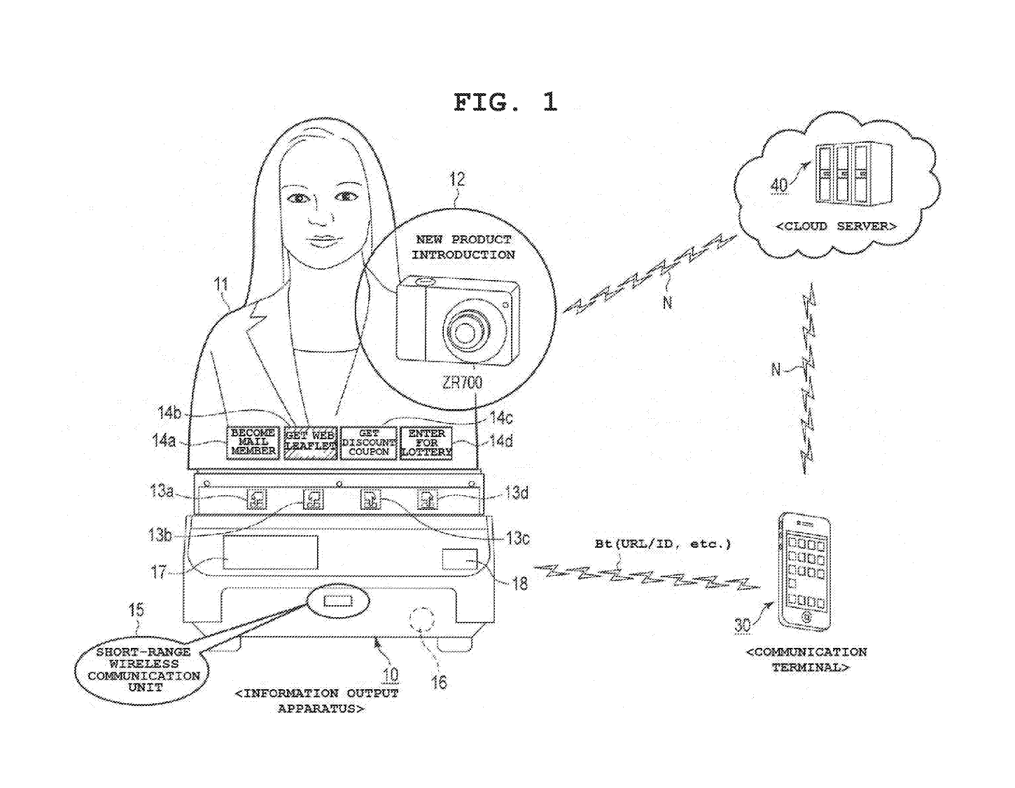

FIG. 1 is a diagram for showing an overall configuration of an electronic notification system relating to an embodiment of an information output apparatus of the present invention.

The electronic notification system includes an advertisement information output apparatus 10, which is disposed in a store of a commercial facility, for example, a user's communication terminal 30 to which the advertisement information output apparatus 10 sends a signal Bt based on a short range wireless communication standard such as the Bluetooth, and a cloud server 40 capable of communicating with each of the advertisement information output apparatus 10 and the communication terminal 30 via a public communication network N.

The advertisement information output apparatus 10 plays back a content of advertisement information generated and transmitted by the cloud server 40 and sends (i.e. broadcast) content information (service information) for acquisition of a coupon corresponding to the content (the advertisement information) which is being played back, or the like, by the short-range wireless communication signal Bt, for example, in response to a request of an installer of the advertisement information output apparatus 10.

The communication terminal 30 is a mobile phone or a PDA (Personal Digital Assistants), for example. The communication terminal 30 receives the service information (such as URL/ID) sent from the advertisement information output apparatus 10 and accesses a web site of the cloud server 40 according to the received service information to receive a service content such as a coupon. An application program for accessing the web site according to the service information (such as the URL/ID) has been downloaded, for example, from the web site and installed in the communication terminal 30 in advance.

The advertisement information output apparatus 10 includes a projection panel 11 on the top. An image is projected onto the back of the projection panel 11 by a short-focus type projector (not shown in the drawings) and is displayed on the front of the projection panel 11. For example, an advertisement image 12 showing an advertisement model is projected onto the projection panel 11 and displayed.

Further, menu selection buttons 13a˜13d are disposed on an upper part of the front of the body of the advertisement information output apparatus 10 so that positions of the buttons correspond to those of menus 14a˜14d for selection of an advertisement content displayed in a lower part of the projection panel 11.

A short-range wireless communication unit (beacon) 15 and a motion sensor 16 are disposed in a lower part of the front of the body of the advertisement information output apparatus 10. The short-range wireless communication signal Bt is sent by the short-range wireless communication unit (beacon) 15.

The motion sensor 16 detects a human being approaching the body of the advertisement information output apparatus 10. In response to detection of approach of a human being by the motion sensor 16, operations to display the advertisement image 12 on the projection panel 11 and send the service information from the short-range wireless communication unit 15 are initiated.

The short-range wireless communication unit 15 complies with the Bluetooth Low Energy (Registered Trademark) communication standard, for example, and broadcasts supplementary information of the content which is being displayed by way of advertisement (beacon). Further, the short-range wireless communication unit 15 may be an independent device connected to the body of the advertisement information output apparatus 10 via a signal cable.

An LCD (liquid crystal display) unit 17 and an NFC (Near Field Communication) reader/writer 18 are disposed in a front panel of the body of the advertisement information output apparatus 10.

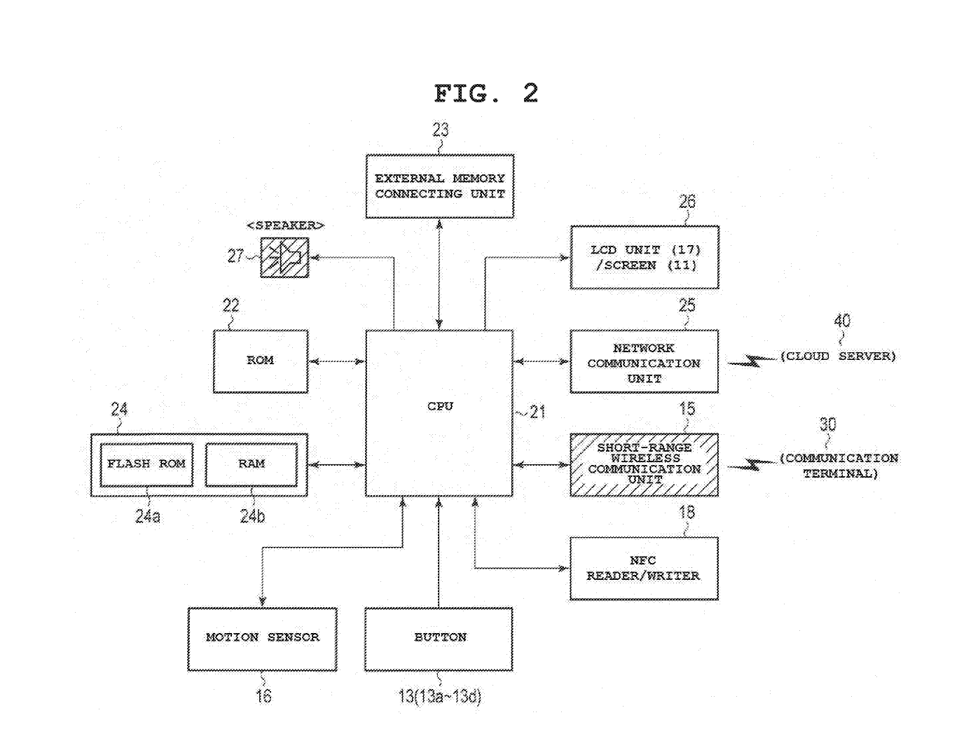

FIG. 2 is a block diagram for showing an electronic circuit of the advertisement information output apparatus 10 of the electronic notification system.

The electronic circuit of the advertisement information output apparatus 10 includes a CPU 21 which can be referred to as a computer. The CPU 21 controls each of units of the circuit according to an apparatus control program stored in a ROM 22, downloaded from a program server (not shown in the drawing) on a communication network N via a network communication unit 25, or read from a memory card (not shown in the drawing) via an external memory connecting unit 23.

Manipulation buttons 13 including the menu selection buttons 13a˜13d, the short-range wireless communication unit 15, the motion sensor 16, a display output unit 26 including a projection display unit (the projector) for the projection panel 11 and the LCD unit 17, the NFC reader/writer 18, the ROM 22, the external memory connecting unit 23, the network communication unit 25, a work memory 24 including a FLASH ROM 24a and a RAM 24b, and a speaker 27 are connected to the CPU 21.

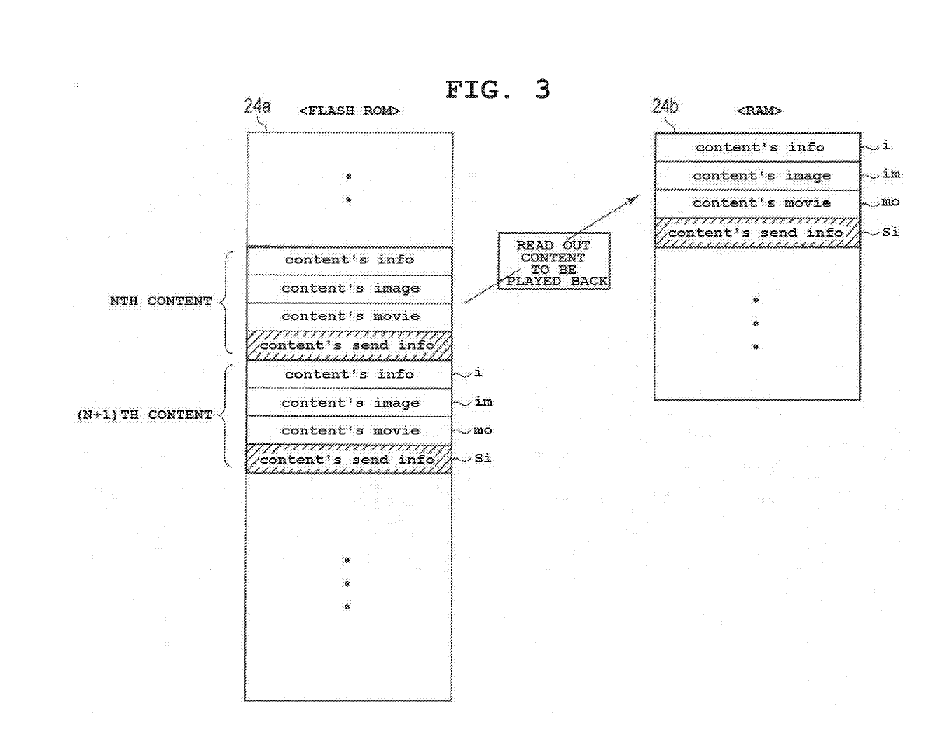

FIG. 3 is a diagram for showing an example of data structure in the FLASH ROM 24a and the RAM 24b of the work memory 24 of the advertisement information output apparatus 10.

In the following, a first embodiment will be described.

The content of the advertisement information output by the advertisement information output apparatus 10 of the first embodiment is generated by the cloud server 40 and downloaded and stored in an external memory card (not shown in the drawings) first via the external memory connecting unit 23.

Then, a group of contents stored in the memory card is recorded in the FLASH ROM 24a in the work memory 24 as shown in FIG. 3. Then, each of the contents is read out to the RAM 24b as shown in FIG. 3 and played back according to an information output process which will be described later.

Each content (N, N+1, . . . ) included in the group of contents includes four kinds of contents as set forth below, for example.

<content's info> i: information on content (name of content, playback schedule, etc.)

<content's image> im: still image for content display

<content's movie> mo: moving picture of content to be played back

<content's send info> si: information to be sent corresponding to content (hereinafter, also referred to as “send information”) (URL/ID, etc.)

The content of the advertisement information generated by the cloud server 40 can be downloaded to an external PC and then stored in the memory card.

In the advertisement information output apparatus 10 configured as described above, the CPU 21 controls each unit of the circuit according to instructions included in a program and an information output function described below is achieved by cooperation of hardware and software.

Then, it is described how the electronic notification system as described above operates.

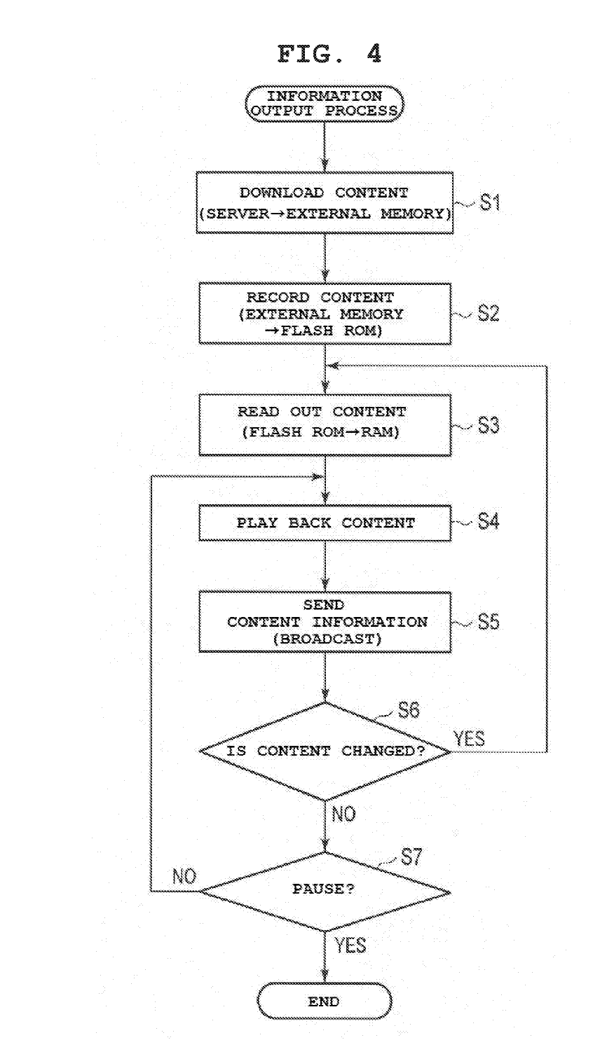

FIG. 4 is a flow chart for showing the information output process performed by the advertisement information output apparatus 10 according to the embodiment.

A plurality of sets of contents (i, im, mo, si) generated by the cloud server 40 are downloaded via the network communication unit 25 and stored in the memory card connected to the external memory connecting unit 23 in response to a request of the installer of the advertisement information output apparatus 10 (Step S1).

The group of contents stored in the memory card is recorded in the FLASH ROM 24a of the work memory 24 as shown in FIG. 3 (Step S2).

Each content (N, N+1, . . . ) of the group of contents recorded in the FLASH ROM 24a is read out to the RAM 24b as shown in FIG. 3 (Step S3).

Then, <content's image> (a still image) im and <content' movie> (a moving picture) mo of the content (i, im, mo, si) read out to the RAM 24b are played back according to <content's info> (a playback schedule) i as the advertisement information. They are projected onto the projection panel 11 and displayed (Step S4).

Further, <content's send info> (URL/ID, etc.) si of the content (i, im, mo, si) read out to the RAM 24b is sent (i.e. broadcasted) from the short-range wireless communication unit 15 as the service information repeatedly at regular time intervals (Step S5).

The content playback Step S4 and the content information sending Step S5 are repeatedly executed according to a continuous playback time period or a number of times of continuous playback described in <content's info> (the playback schedule) i (Step S6 (NO)->S7 (NO)->S4, S5).

In the case that repetition of the content playback Step S4 and the content information sending Step S5 reaches the continuous playback time period or the number of times of continuous playback, it is determined that the content should be changed (Step S6: YES). Then, the next content is read out to the RAM 24b from the group of contents recorded in the FLASH ROM 24a (Step S3).

Similarly to the above, <content's image> (a still image) im and <content' movie> (a moving picture) mo of the next content (i, im, mo, si) read out to the RAM 24b are played back according to <content's info> (a playback schedule) i as the advertisement information. They are projected onto the projection panel 11 and displayed (Step S4). Further, <content's send info> (URL/ID, etc.) si is sent (i.e. broadcasted) from the short-range wireless communication unit 15 as the service information repeatedly at regular time intervals (Step S5).

Then, in the case that no human being is detected near the body of the apparatus 10 by the motion sensor 16 or an instruction for pause is issued by a manipulation of the installer of the apparatus 10 (Step S7: YES), the information output process ends.

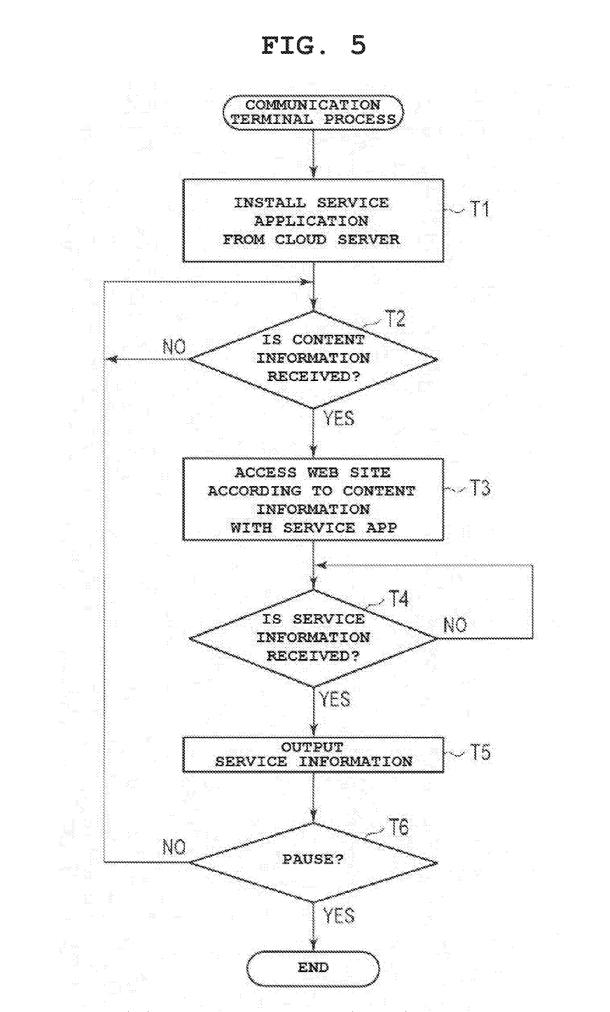

FIG. 5 is a flow chart for showing a process performed by the communication terminal 30 of the electronic notification system according to the embodiment of the present invention.

The communication terminal 30 accesses a web site of the cloud server 40 generating the contents (the advertisement information) to be played back by the advertisement information output apparatus 10 according to a manipulation of the user installs an application program for receiving services from the web site (Step T1).

Then, in the case that the user possessing the communication terminal 30 approaches the advertisement information output apparatus 10 and sees the content (the advertisement information) which is being played back by the advertisement information output apparatus 10, the communication terminal 30 receives the content information <content's send info> (URL/ID, etc.) si sent from the advertisement information output apparatus 10 by the short-range wireless communication signal Bt (Step T2: YES). The communication terminal 30 accesses a web site of the cloud server 40 corresponding to the received content information (URL/ID, etc.) (Step T3).

In the case that the service information such as a coupon is received from the web site of the cloud server 40 accessed by the communication terminal 30 (Step T4: YES), the service information is output and displayed by a display unit and the like. Thus, the communication terminal 30 can receive services related to the content of the advertisement information played back by the advertisement information output apparatus 10 (Step T5).

Therefore, the advertisement information output apparatus 10 of the electronic notification system configured as described above downloads and acquires the content (im, mo) as the advertisement information and the content information (Si) corresponding to the advertisement information as the service information from the cloud server 40. Then, the downloaded advertisement information (the content (im, mo)) is projected onto the projection panel 11 and displayed to become known to the user approaching to the body of the apparatus. Further, the service information (the content information (Si)) for acquisition of the coupon corresponding to the advertisement information which is being displayed can be sent (i.e. broadcasted) by the short-range wireless communication signal Bt and provided to the user's communication terminal 30.

By this, the user can receive and acquire the supplementary service information related to the information such as the advertisement while seeing the information.

Further, the advertisement information output apparatus 10 of the electronic notification system configured as described above downloads and acquires a plurality of pieces of advertisement information (the contents (im, mo)) and the service information (Si) corresponding to each advertisement information (the content (im, mo)) from the cloud server 40. Further, in the case that the advertisement information (the content (im, mo)) to be projected onto the projection panel 11 and displayed is changed sequentially, the service information corresponding to the changed advertisement information is sent (i.e. broadcasted).

By this, it is possible to effectively provide the user with the service information such as a plurality of kinds of coupons corresponding to the information such as a plurality of kinds of advertisements.

In the present embodiment, the advertisement information output apparatus 10 sends (i.e. broadcasts) the service information (the content information (Si)) corresponding to the advertisement information (the content (im, mo) which is being projected onto the projection panel 11 and displayed by the short-range wireless communication unit 15 using the Bluetooth. In a different embodiment, the service information can be sent by an ultrasonic wave signal output from the speaker 27.

In the following, a second embodiment will be described.

The short-range wireless communication unit 15 of the second embodiment performs short-range wireless communication with an external device by the Bluetooth Low Energy (BLE) communication technology. More specifically, the short-range wireless communication unit 15 which is a transmission means broadcasts the send information including ID information at a set transmission intensity based on a HCI (Host Control Interface) command set by the CPU 21.

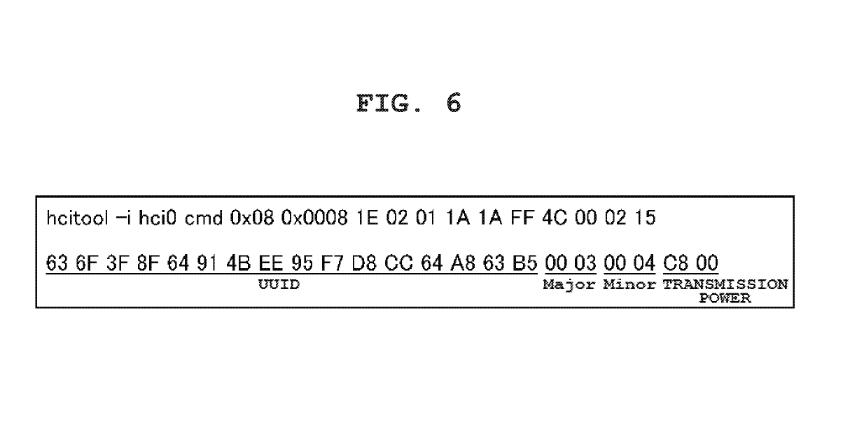

FIG. 6 is a diagram for showing an example of the HCI command. As shown in FIG. 6, the HCI command includes UUID, Major, Minor and TRANSMISSION POWER. The ID information for identifying a service which can be received by the communication terminal 30 includes three identifiers, i.e. UUID, Major and Minor. The short-range wireless communication unit 15 broadcasts the send information of a predetermined format including the ID information at regular time intervals. The TRANSMISSION POWER is information for showing transmission power at which the ID information included in the HCI command is broadcasted. The short-range wireless communication unit 15 broadcasts the send information at a transmission intensity (a radio wave intensity) corresponding to the TRANSMISSION POWER included in the set HCI command.

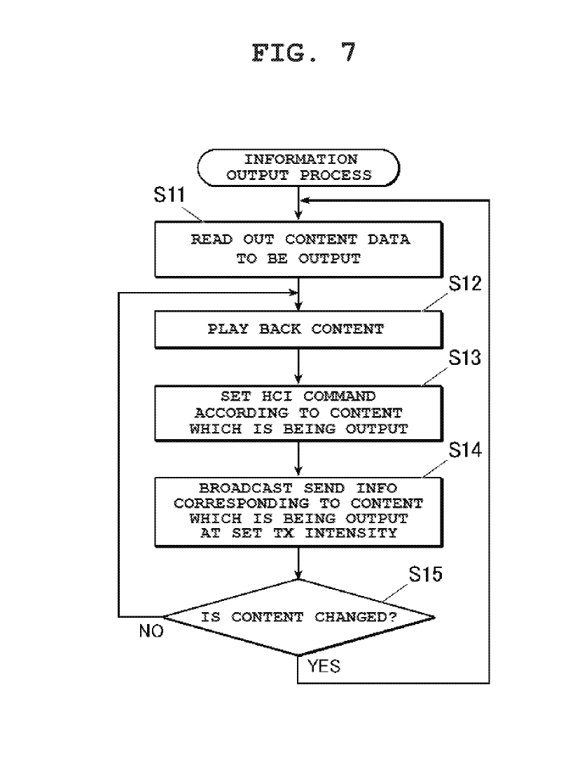

FIG. 7 is a flow chart for showing how the advertisement information output apparatus 10 according to the present embodiment operates.

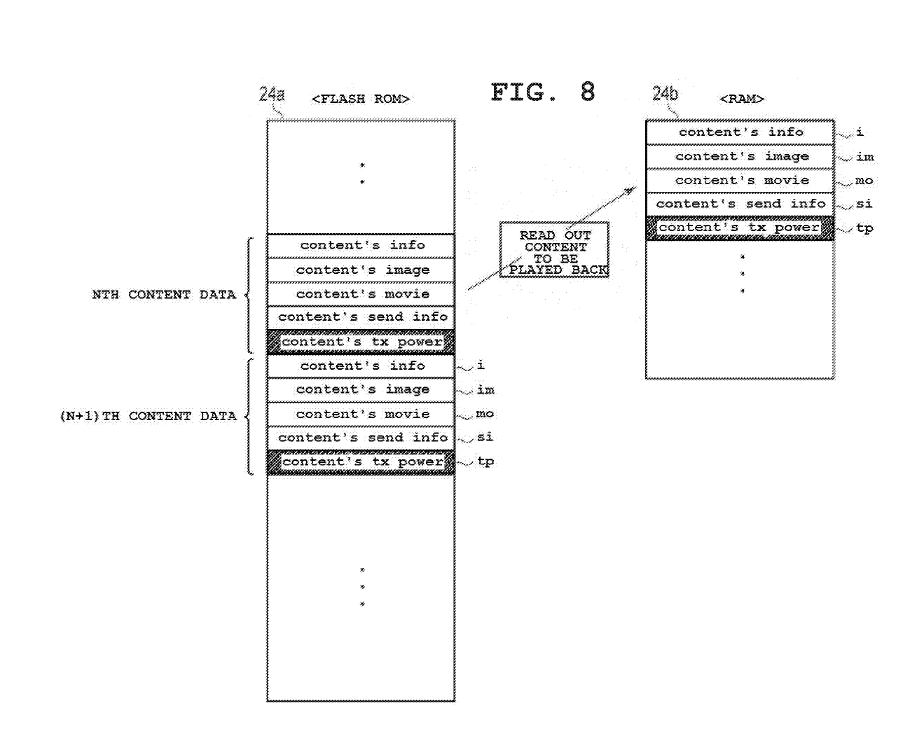

A group of contents stored in the memory card is recorded in the FLASH ROM 24a in the work memory 24 as shown in FIG. 8 (Step S11). Each of the contents is read out to the RAM 24b sequentially as shown in FIG. 8 and played back (Step S12).

Each content (N, N+1, . . . ) included in the group of contents includes five kinds of contents as set forth below, for example.

<content's info> i: is information on content (name of content, playback schedule, etc.)

<content's image> im: still image for content display

<content's movie> mo: moving picture of content to be played back

<content's, send info> si: send information corresponding to content (URL/ID, etc.)

<content's tx power> tp: transmission intensity corresponding to content.

The content of the advertisement information generated by the cloud server 40 can be downloaded to an external PC and then stored in the memory card.

Then, the CPU 21 sets the HCI command of the short-range wireless communication unit 15 according to the content which is being output (Step S13).

More specifically, the CPU 21 acquires the send information (content's send info) and the transmission intensity (content's tx power) read out to the RAM 24b and changes UUID, Major and Minor of the HCI command and TRANSMISSION POWER previously set for the short-range wireless communication unit 15 to UUID, Major and Minor of the acquired send information and the acquired transmission intensity, respectively. In other words, the short-range wireless communication unit 15 is set for the ID information and the transmission intensity corresponding to the content which is being output.

The short-range wireless communication unit 15 broadcasts the send information in a predetermined format based on the HCI command set by the CPU 21 (Step S14).

Then, the CPU 21 determines whether or not the content is changed (Step S15).

In the case it is determined that that the content is not changed (Step S15; NO), the CPU 21 returns to Step S12. In the case it is determined that that the content is changed (Step S15; YES), the CPU 21 returns to Step S11. Then, content data of a content which is to be output next is read out from the FLASH ROM 24a and Steps S11 to S15 are performed.

The CPU 21 repeats to perform Steps S11 to S15 until the advertisement information output apparatus 10 is turned off.

The advertisement information output apparatus 10 stores the ID information of a service and/or the transmission intensity corresponding to the content in correspondence with data for output of the content (image data and/or voice data) in the FLASH ROM 24a. The CPU 21 reads out the ID information and/or the transmission intensity corresponding to the content from the FLASH ROM 24a during outputting the content and sets the HCI command including the read ID information and/or transmission intensity for the short-range wireless communication unit 15. The short-range wireless communication unit 15 broadcasts the send information including the set ID information at the set transmission intensity.

Thus, it is possible to dynamically change the send information broadcasted by the short-range wireless communication unit 15 and the transmission intensity at which the send information is broadcasted by the short-range wireless communication unit 15 according to the content which is being output. Therefore, it is possible to transmit information related to the content which is being output within a proper range corresponding to the content.

For example, in the case that it is desired to distribute coupons of a product which is being introduced in a content only to persons who are seeing the content, it is possible to limit the range of sending the ID information for distributing the coupons of the product which is being introduced in the content by reducing the transmission intensity. Further, in the case of playing back a content about a new product, for example, it is possible to transmit the ID information corresponding to access to a homepage of the new product to a wide range of customers by increasing the transmission intensity in order to widely advertise the new product.

Conventionally, a beacon outputting send info by the BLE cannot change the transmission intensity dynamically because a change in the transmission intensity requires a change in setting by a dedicated tool or a dedicated application. By the information output process of the embodiment, it is possible to transmit information related to a content which is being output within a proper range corresponding to the content because the transmission intensity can be dynamically changed according to the content. Therefore, convenience is improved.

The embodiments described above are desirable examples of the electronic notification system of the present invention descriptions but the present invention is not limited to the embodiments.

For example, in the above embodiment, the ID information included in the send information broadcasted during output of the content and the transmission intensity are changed according to the content which is being output. However, in some embodiments, the ID information may not be changed and the transmission intensity may be changed. For example, the ID information shows a service received from the cloud server 40. In this case, a content playback schedule of the advertisement information output apparatus 10 is stored in a memory of the cloud server 40. Thus, the cloud server 40 can identify the content which is being output even if the ID information included in the send information is the same. Therefore, a service corresponding to the content which is being output can be provided by the cloud server 40. For example, it is possible to transmit a coupon corresponding to the content which is being output to the communication terminal 30 in response to access from the communication terminal 30.

Each process performed by the electronic notification system described in each of the embodiments, i.e. the information output process performed by the advertisement information output apparatus 10 shown in the flowchart of FIG. 4, the communication terminal process performed by the communication terminal 30 shown in the flowchart of FIG. 5, or the information output process performed by the advertisement information output apparatus 10 shown in the flowchart of FIG. 7, can be realized as a computer executable program which can be stored in a recording medium which is an external memory such as a memory card (a ROM card, a RAM card, or the like), a magnetic disk (a floppy (Registered Trademark) disk, a hard disk, or the like), an optical disc (a CD-ROM, a DVD, or the like), or a semiconductor memory, and distributed. Further, a processor (or the CPU) of an electronic apparatus, which includes the display device 11 and the communication device 15, reads the program stored in the recording medium which is the external memory to a storage device and controls operations of the electronic apparatus according to the program. By this, the information output function described in each of the embodiments can be realized and the processes can be executed in the way as described above.

Further, program data for realizing each process can be transmitted on the communication network N in a form of program codes. The program data can be transmitted from a computer apparatus (a program server) connected to the communication network N to an electronic apparatus including the display device 11 and the communication device 15. The information output function can be realized by the program data received by the electronic apparatus and stored in a storage device of the electronic apparatus.

Although some embodiments of the present invention have been described above, it should be understood that they have been presented merely by way of example and do not limit the technical scope of the present invention. Various different embodiments and modifications may be made without departing from the spirit of the invention. Each of the embodiments includes various elements and/or steps and various inventions can be made by combinations of the elements and/or steps. For example, modification such as omission of some elements from all of the elements of each of the embodiments, or a combination of some elements in a different ways from each of the embodiments can constitute an invention if the modification can achieve the object described here. The embodiments and modifications are included in the scope of the invention described in the specification and the drawings and the scope of the general inventive concept as defined by the appended claims and their equivalents.

What is claimed is:

1. An information output apparatus comprising:
a content output unit configured to output a content; and
a broadcast unit configured to broadcast information related to the content which is being output by the content output unit.

2. The information output apparatus of claim 1 further comprising an information acquisition unit configured to acquire a content to be output and information related to the content,
wherein the content output unit outputs the content acquired by the information acquisition unit, and the broadcast unit broadcasts the information related to the content which is being output by the content output unit, the information being acquired by the information acquisition unit.

3. The information output apparatus of claim 2, wherein the information acquisition unit acquires a plurality of sets of contents to be output and information related to each of the contents,
the content output unit comprises a content change unit configured to change a content output by the content output unit from one content of a plurality of contents acquired by the information acquisition unit to a different one of the plurality of contents, and
in the case that the content output by the content output unit is changed to the different content by the content change unit, the broadcast unit broadcasts information related to the different content.

4. The information output apparatus of claim 1, wherein broadcast unit broadcasts the information at a transmission intensity based on the content which is being output by the content output unit.

5. The information output apparatus of claim 2, wherein broadcast unit broadcasts the information at a transmission intensity based on the content which is being output by the content output unit.

6. The information output apparatus of claim 3, wherein broadcast unit broadcasts the information at a transmission intensity based on the content which is being output by the content output unit.

7. The information output apparatus of claim 1, wherein the broadcast unit is a beacon sending unit for sending the information related to the content which is being output by the content output unit as a short-range wireless signal.

8. The information output apparatus of claim 2, wherein the broadcast unit is a beacon sending unit for sending the information related to the content which is being output by the content output unit as a short-range wireless signal.

9. The information output apparatus of claim 3, wherein the broadcast unit is a beacon sending unit for sending the information related to the content which is being output by the content output unit as a short-range wireless signal.

10. The information output apparatus of claim 4, wherein the broadcast unit is a beacon sending unit for sending the information related to the content which is being output by the content output unit as a short-range wireless signal.

11. The information output apparatus of claim 5, wherein the broadcast unit is a beacon sending unit for sending the information related to the content which is being output by the content output unit as a short-range wireless signal.

12. The information output apparatus of claim 6, wherein the broadcast unit is a beacon sending unit for sending the information related to the content which is being output by the content output unit as a short-range wireless signal.

13. The information output apparatus of claim 1, wherein the broadcast unit is an ultrasonic wave sending unit for sending the information related to the content which is being output by the content output unit as an ultrasonic wave signal.

14. The information output apparatus of claim 2, wherein the broadcast unit is an ultrasonic wave sending unit for sending the information related to the content which is being output by the content output unit as an ultrasonic wave signal.

15. The information output apparatus of claim 3, wherein the broadcast unit is an ultrasonic wave sending unit for sending the information related to the content which is being output by the content output unit as an ultrasonic wave signal.

16. The information output apparatus of claim 4, wherein the broadcast unit is an ultrasonic wave sending unit for sending the information related to the content which is being output by the content output unit as an ultrasonic wave signal.

17. The information output apparatus of claim 5, wherein the broadcast unit is an ultrasonic wave sending unit for sending the information related to the content which is being output by the content output unit as an ultrasonic wave signal.

18. The information output apparatus of claim 1, wherein the content is advertisement information and the information related to the content is service information related to the advertisement information.

19. An information output apparatus comprising:
a content output unit configured to output a content; and
a broadcast unit configured to broadcast information at a transmission intensity based on the content which is being output by the content output unit.

20. An information output method for outputting information by controlling an information output apparatus, which comprises a display unit and a sending unit, comprising:
displaying a content on the display unit; and
broadcasting information related to the content which is being displayed on the display unit by the sending unit.

21. An information output method for outputting information by controlling an information output apparatus, which comprises a display unit and a sending unit, comprising:
displaying a content on the display unit; and
broadcasting the information at a transmission intensity based on the content which is being displayed on the display unit by the sending unit.

22. A non-transitory computer-readable recording medium for recording a program comprising instructions executable by a processor of an information output apparatus, which comprises a display unit and a sending unit, the program causing, when executed, the information output apparatus to perform operations to:
display a content on the display unit; and
broadcast information related to the content which is being displayed on the display unit by the sending unit.

23. A non-transitory computer-readable recording medium for recording a program comprising instructions executable by a processor of an information output apparatus, which comprises a display unit and a sending unit, the program causing, when executed, the information output apparatus to perform operations to:
display a content on the display unit; and
broadcast the information at a transmission intensity based on the content which is being displayed on the display unit by the sending unit.
